(19) United States
(12) Patent Application Publication
(10) Pub. No.: US 2003/0088724 A1
(43) Pub. Date: May 8, 2003

(54) Asynchronous bus interface apparatus

(76) Inventors: Kenichi Itoh, Kanagawa (JP); Ryousaku Kobayashi, Kanagawa (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/262,888

(22) Filed: Oct. 3, 2002

(30) Foreign Application Priority Data
Oct. 4, 2001 (JP) 308279/ 2001

(51) Int. Cl. G06F 13/24

(52) U.S. Cl. 710/262

(57) ABSTRACT

An asynchronous bus interface apparatus includes an external register, arbitrating section, internal register, and state management control section. The external register temporarily stores write data for a microprocessor in accordance with a write request signal sent from the microprocessor via an asynchronous bus. The arbitrating section generates an internal register write signal in synchronism with an operation clock from a macro circuit upon reception of the write request signal from the microprocessor. The internal register reads data output from the external register when the internal register write signal is input from the arbitrating section, temporarily stores the data, and outputs the stored data in synchronism with the operation clock from the macro circuit. The state management control section recognizes the difference between a data storage timing in the external register and a data storage timing in the internal register, and suppresses generation of an interrupt in an interval corresponding to the difference.

### BACKGROUND OF THE INVENTION

The present invention relates to an asynchronous bus interface apparatus arranged between an asynchronous bus and a macro circuit of a microcomputer.

Recently, attempts have been made to realize a faster CPU (Central Processing Unit) in a system constituted by the CPU and external peripheral devices, e.g., a microcomputer system which is designed to be incorporated in various devices to control the devices. In contrast to this, some peripheral devices include mechanical operations, and some analog input devices are difficult to achieve an increase in speed. Furthermore, in some devices, an increase in speed leads to an abrupt increase in power consumption. For this reason, there is strong demand for greater power savings, and hence the operating frequencies of peripheral devices tend to decrease.

This means that in the operations of a peripheral device, a wait cycle for a bus increases, resulting in a deterioration in performance. As the response time of the peripheral device increases with an increase in relative difference in operating frequency between a CPU and a peripheral function, the bus wait time prolongs when data is transferred from the CPU to a peripheral device, resulting in a deterioration in processing performance.

As a method of solving such a problem, a microcomputer system to be incorporated in a device is known, which has an asynchronous bus interface apparatus arranged between an asynchronous bus and a peripheral device. The asynchronous bus interface apparatus receives data by handshaking with a CPU via an asynchronous bus, temporarily stores the data, and outputs the temporarily stored data to a peripheral device in synchronism with the operation clock frequency of the peripheral device.

As shown in FIG. 9, a conventional microcomputer system includes a CPU 8-1, an asynchronous bus 8-2, a plurality of macro circuits 8-3, and a plurality of asynchronous bus interfaces (IFs) 8-4. The asynchronous bus interfaces 8-4 includes an external register 8-5, internal register 8-6, arbitrating section 8-7, interrupt determining section 8-8, and interrupt control section 8-9. In order to adjust the difference in operating frequency between the CPU 8-1 and the asynchronous bus interfaces 8-4, the external register 8-5 capable of high-speed operation is connected to the asynchronous bus 8-2, and the internal register 8-6 corresponding to a low-speed peripheral device is connected to the output stage of the external register 8-5.

The CPU 8-1 sends a write request signal to the asynchronous bus interfaces 8-4 via the asynchronous bus 8-2. The external register 8-5 receives and stores write data from the CPU 8-1 in accordance with the write request signal sent from the CPU 8-1 via the asynchronous bus 8-2. The external register 8-5 sends the stored data (external register value) to the internal register 8-6 in synchronism with an internal clock signal. The arbitrating section 8-7 sets an internal write request flag in accordance with the write request from the CPU 8-1, and sends an internal register write signal to the internal register 8-6.

When the internal register write signal is output from the arbitrating section 8-7, the internal register 8-6 receives and stores the write data output from the external register 8-5. The stored data (internal register value) is sent to the interrupt determining section 8-8. The interrupt determining section 8-8 compares the internal register value output from the internal register 8-6 with a predetermined interrupt generation conditional value. If they coincide with each other, the interrupt determining section 8-8 sends an interrupt generation signal to the interrupt control section 8-9. The interrupt control section 8-9 outputs an interrupt generation flag in accordance with the interrupt generation signal from the interrupt determining section 8-8 and an external interrupt clear signal.

The operation of the arbitrating section 8-7 will be described next with reference to FIG. 10. Upon reception of a write request from the CPU 8-1 (step S91), the arbitrating section 8-7 sets an internal write request flag (step S92), and checks whether a new write request is generated by the CPU 8-1 (step S93). If a write request is generated, the flow returns to step S92. If no new write request is generated, the arbitrating section 8-7 resets the write request flag (step S94), and sends an internal register write signal to the internal register 8-6 (step S95).

According to the above conventional asynchronous bus interface apparatus, however, the problem shown in FIGS. 11A to 11F arises. The external register 8-5 receives data “K” sent from the CPU 8-1 at the trailing edge of a write request signal from the CPU 8-1 (FIGS. 11A and 11C). In general, the CPU 8-1 outputs an interrupt clear signal like the one shown in FIG. 11B after the transmission of a write request signal to prevent data “M” from causing an interrupt before the data “K” is written in the internal register 8-6. An interrupt by the data “M” before a write is cleared by this interrupt clear signal.

Assume, however, that the timing of a write in the internal register 8-6 is later than the timing of the interrupt clear signal (FIG. 1D). In this case, if an internal register value coincides with an external interrupt generation conditional value before the completion of writing of the data “K” in the internal register 8-6, an interrupt is generated (FIGS. 11E and In order to avoid the generation of such an interrupt, a method like that shown in FIG. 12A to 12G may be used. The external register 8-5 receives the data “K” sent from the CPU 8-1 at the trailing edge of a write request signal from the CPU 8-1 (FIGS. 12A and 12D). In this case, as shown in FIG. 12E, in consideration of a delay in writing data in the internal register 8-6, the CPU 8-1 outputs an interrupt clear signal after a lapse of a time required to write the data in the internal register 8-6 (FIG. 12B). FIG. 12C shows a CPU clock signal.

Even if an internal register value coincides with an interrupt generation conditional value and an interrupt generation signal is generated (FIG. 12F), the interrupt generation flag is cleared by the interrupt clear signal (FIG. 12G). This makes it possible to prevent the data “M” from causing an interrupt before the data “K” is written in the internal register 8-6.

The method shown in FIGS. 12A to 12G, however, often imposes restrictions on the creation of software and makes it difficult to create software. In addition, since the CPU 8-1 is occupied during this interval, the response speed and CPU utilization efficiency decrease.

### SUMMARY OF THE INVENTION

It is an object of the present invention to provide an asynchronous bus interface apparatus which has no restrictions on software and causes no decrease in CPU utilization efficiency.

In order to achieve the above object, according to the present invention, there is provided an asynchronous bus interface apparatus arranged between an asynchronous bus and a macro circuit, comprising external register means which temporarily stores write data for a microprocessor in accordance with a write request signal sent from the microprocessor via the asynchronous bus, arbitrating means for generating an internal register write signal in synchronism with an operation clock from the macro circuit upon reception of the write request signal from the microprocessor, internal register means which reads data output from the external register means when the internal register write signal is input from the arbitrating means, temporarily stores the data, and outputs the stored data in synchronism with the operation clock from the macro circuit, and state management control means for recognizing a difference between a data storage timing in the external register means and a data storage timing in the internal register means, and suppresses generation of an interrupt in an interval corresponding to the difference.

### BRIEF DESCRIPTION OF THE DRAWINGS

FIG. 1 is a block diagram showing the arrangement of a microcomputer system according the first embodiment of the present invention;

FIGS. 2A to 2G are timing charts showing the operation of an asynchronous bus interface apparatus shown in FIG. 1;

FIG. 3 is a flow chart showing the operations of an interrupt control section and state management control section in FIG. 1;

FIG. 4 is a block diagram showing the arrangement of a microcomputer system according to the second embodiment of the present invention;

FIG. 5 is a block diagram showing the arrangement of a microcomputer system according to the third embodiment of the present invention;

FIGS. 6A to 6G are timing charts showing the operation of the asynchronous bus interface apparatus in FIG. 5;

FIG. 7 is a block diagram showing the arrangement of a microcomputer system according to the fourth embodiment of the present invention;

FIG. 8 is a block diagram showing the arrangement of a watch dog timer in FIG. 7;

FIG. 9 is a block diagram showing the arrangement of a microcomputer system having a conventional asynchronous bus interface apparatus;

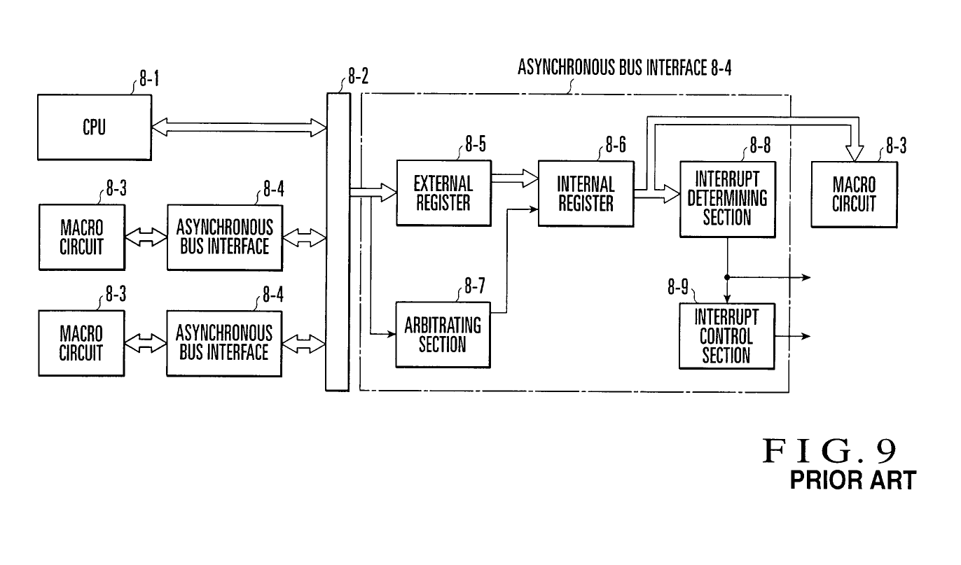

FIG. 10 is a flow chart showing the operation of an arbitrating section in FIG. 9;

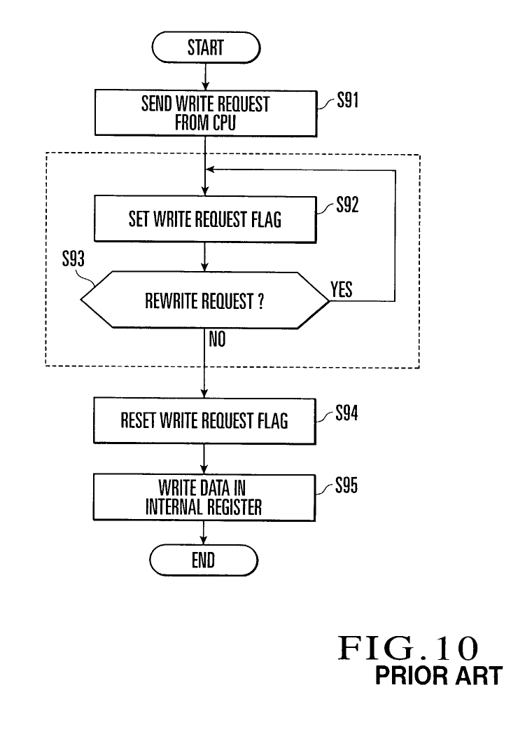

FIGS. 11A to 11F are timing charts showing the operation of the conventional asynchronous bus interface apparatus shown in FIG. 9; and

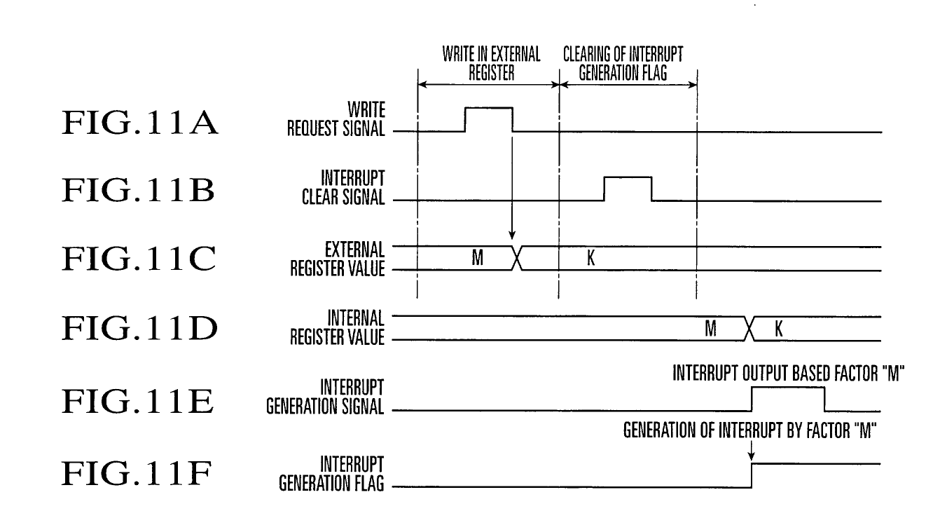

FIGS. 12A to 12G are timing charts showing an improved example of the operation of the conventional asynchronous bus interface apparatus shown in FIG. 9.

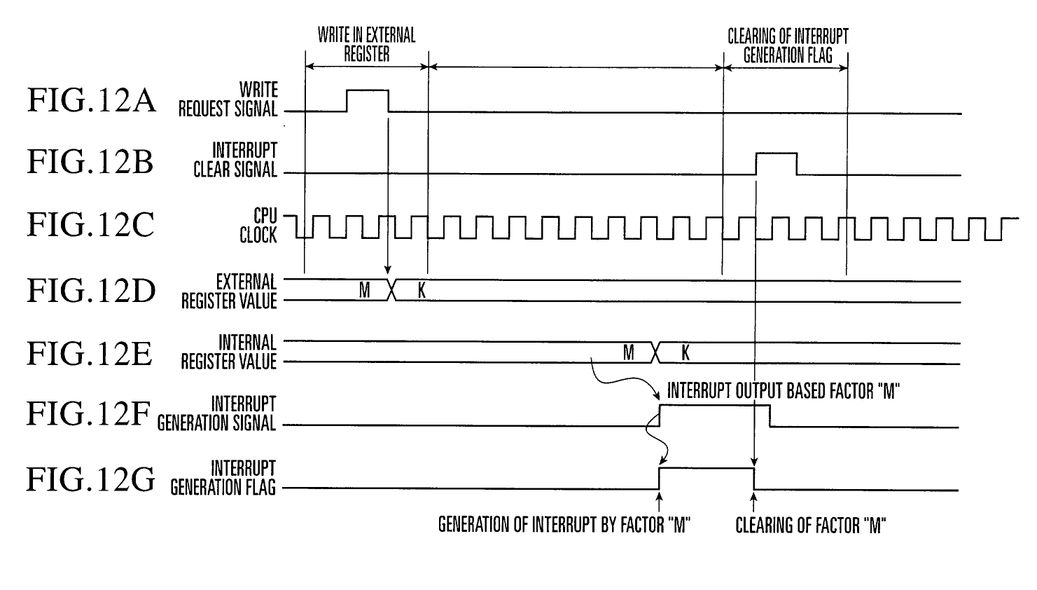

### DESCRIPTION OF THE PREFERRED EMBODIMENTS

The present invention will be described in detail below with reference to the accompanying drawings.

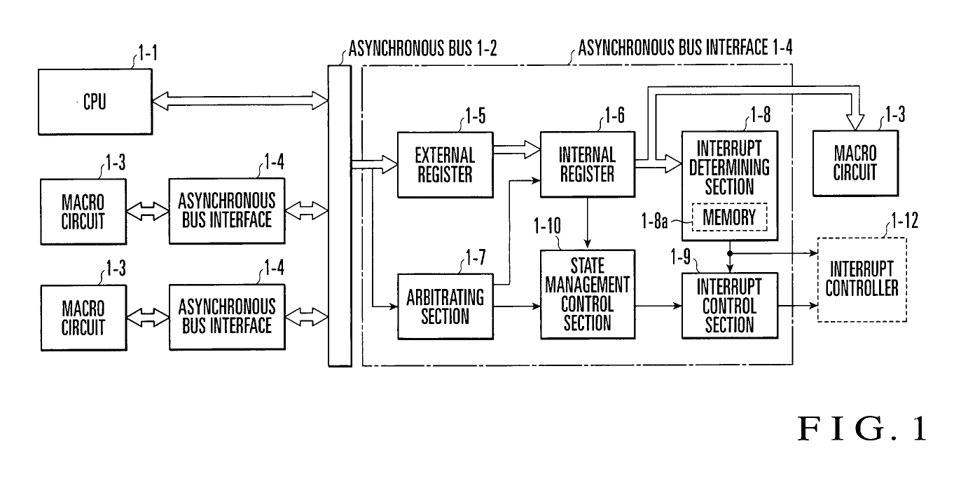

FIG. 1 shows a microcomputer system according to the first embodiment of the present invention. The microcomputer system shown in FIG. 1 includes a CPU 1-1, an asynchronous bus 1-2, a plurality of macro circuits 1-3 connected to the CPU 1-1 via the asynchronous bus 1-2, and a plurality of asynchronous bus interfaces (IFs) 1-4 connected between the asynchronous bus 1-2 and the macro circuits 1-3.

The asynchronous bus interface 1-4 includes an external register 1-5 connected to the asynchronous bus 1-2, an internal register 1-6 connected to the external register 1-5, an arbitrating section 1-7 connected to the asynchronous bus 1-2, an interrupt determining section 1-8 connected to the internal register 1-6, an interrupt control section 1-9 connected to the interrupt determining section 1-8, and a state management control section 1-10 connected to the internal register 1-6, arbitrating section 1-7, and interrupt control section 1-9.

The CPU 1-1 sends write data and a write request signal to the asynchronous bus interface 1-4 via the asynchronous bus 1-2. The CPU 1-1 also sends an address indicting the asynchronous bus interface 1-4 as a destination address. For the sake of descriptive convenience, however, a description of this address will be omitted.

The external register 1-5 receives and stores the write data from the CPU 1-1 in accordance with the write request signal sent from the CPU 1-1 via the asynchronous bus 1-2. The external register 1-5 sends the stored data (external register value) to the internal register 1-6 in synchronism with an internal clock (an operation clock for the macro circuit).

The arbitrating section 1-7 sets its internal write request flag in accordance with the write request from the CPU 1-1, and sends an internal register write signal to the internal register 1-6. When the internal register write signal is output from the arbitrating section 1-7, the internal register 1-6 receives and stores the write data output from the external register 1-5. The stored data (internal register value) is sent to the interrupt determining section 1-8.

The interrupt determining section 1-8 compares the internal register value output from the internal register 1-6 with a predetermined interrupt generation conditional value stored in a memory 1-8a. When they coincide with each other, the interrupt determining section 1-8 sends an interrupt generation signal to the interrupt control section 1-9 and external state management control section 1-10. The state management control section 1-10 generates an interrupt suppression signal on the basis of the write request signal sent from the CPU 1-1 via the arbitrating section 1-7 and the internal register write end signal output from the internal register 1-6 upon completion of a data write.

Upon reception of the interrupt generation signal from the interrupt determining section 1-8 and the interrupt suppression signal from the state management control section 1-10, the interrupt control section 1-9 controls an interrupt generation flag. If an interrupt generation signal is output and no interrupt suppression signal is output, the interrupt control section 1-9 turns on the interrupt generation flag. If an interrupt generation signal is output and an interrupt suppression signal is output, the interrupt generation flag is kept OFF.

The interrupt generation signal and interrupt generation flag are held and managed by an external interrupt controller 1-10. The interrupt generation signal indicates the generation of an interrupt itself. The interrupt generation flag indicates from where this interrupt is generated. Even if an interrupt generation signal is held, the interrupt controller 1-10 does not recognize the generation of an interrupt unless the corresponding interrupt generation flag is OFF. Only when an interrupt generation signal is output and the corresponding interrupt generation flag is ON, the interrupt controller generates an interrupt in the corresponding macro circuit 1-3. The macro circuit 1-3 in which the interrupt is generated obtains an internal register value from the internal register 1-6 in the asynchronous bus interface 1-4.

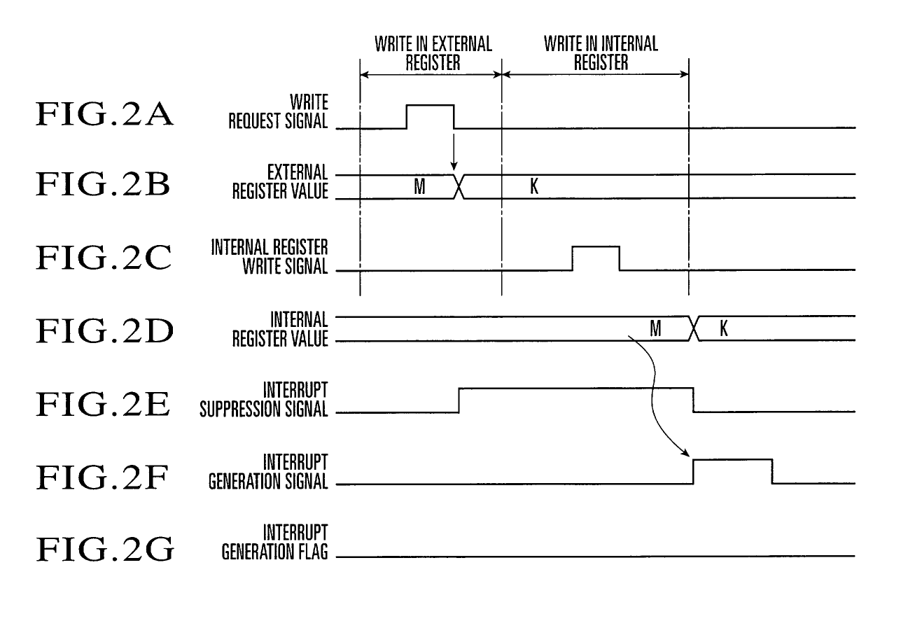

The above operation of each asynchronous bus interface will be described in more detail next with reference to FIGS. 2A to 2G. First of all, the CPU 1-1 sends write data (value) “K” and a write request signal (FIG. 2A) to the external register 1-5 via the asynchronous bus 1-2. The external register 1-5 receives the write data “K” in accordance with the write request signal. As a consequence, the external register value changes from a previous value “M” to the new value “K” (FIG. 2B).

The external register 1-5 sends the new external register value “K” to the internal register 1-6. The arbitrating section 1-7 sets an internal write request flag in accordance with the write request from the CPU 1-1 and sends an internal register write signal to the internal register 1-6 (FIG. 2C). The arbitrating section 1-7 also sends the write request signal sent from the CPU 1-1 to the state management control section 1-10.

When the internal register write signal is output from the arbitrating section 1-7, the internal register 1-6 receives the write data output from the external register 1-5 and rewrites the internal register value. However, since the internal register 1-6 follows an operation clock from the macro circuit 1-3, the operation speed of the register is lower than that of the CPU 1-1 and the like. For this reason, the internal register 1-6 rewrites the internal register value with a delay from the internal register write signal (FIG. 2D).

The state management control section 1-10 generates an interrupt suppression signal on the basis of the write request signal sent from the CPU 1-1 via the arbitrating section 1-7 and the internal register write signal output from the internal register 1-6, and sends the interrupt suppression signal to the interrupt control section 1-9 (FIG. 2E). This interrupt suppression signal rises from Low level to High level in accordance with the trailing edge of the write request signal, and falls to Low level in accordance with the internal register write end signal.

The interrupt determining section 1-8 compares the internal register value output from the internal register 1-6 with a predetermined interrupt generation conditional value. The interrupt generation conditional value is stored as a fixed value in a memory 1-6a in the interrupt determining section 1-8 in advance. If the two values coincide with each other, the interrupt determining section 1-8 outputs an interrupt generation signal to the interrupt control section 1-9 and external interrupt controller 1-10. In this embodiment, the interrupt determining section 1-8 outputs an interrupt generation signal in accordance with the data “M” before the data “K” is written in the internal register 1-6 (FIG. 2F).

The interrupt control section 1-9 receives the interrupt generation signal output from the interrupt determining section 1-8 and the interrupt suppression signal output from the state management control section 1-10, and ON/OFF-controls the interrupt generation flag. In this embodiment, since the interrupt suppression signal is output from the state management control section 1-10, even if the interrupt generation signal is set at High level by the data “M” before the completion of an internal register rewrite, the interrupt control section 1-9 does not change the interrupt generation flag and keeps it off (Low level) (FIG. 2G).

According to this embodiment, the time interval between the register value rewrite start time in the external register 1-5 and the register value rewrite end time in the internal register 1-6 is set as an interrupt suppression interval on the basis of a write request signal from the CPU 1-1 to the external register 1-5 and an internal register write end signal from the internal register 1-6. Since the state management control section 1-10 generates an interrupt suppression signal and supplies it to the interrupt control section 1-9 during this interrupt suppression interval, even if the interrupt determining section 1-8 generates an interrupt generation signal, the generation of an actual interrupt can be prevented. This makes it possible to prevent the asynchronous bus interface 1-4 from starting internal operation under a wrong interrupt condition.

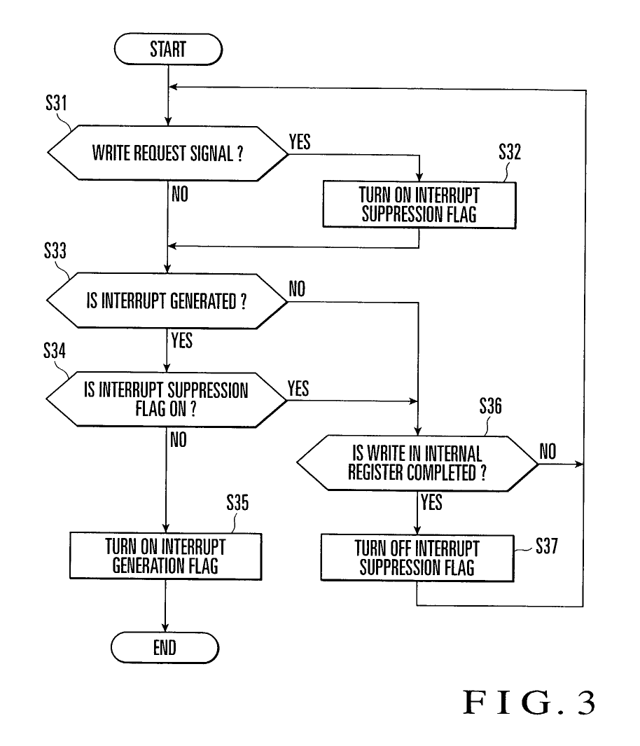

The operations of the state management control section 1-10 and interrupt control section 1-9 will be described in detail next with reference to FIG. 3. Upon reception of a write request signal from the CPU 1-1 via the arbitrating section 1-7 (step S31), the state management control section 1-10 turns on the internal interrupt suppression flag and outputs an interrupt suppression signal (step S32).

The interrupt determining section 1-8 compares the internal register value with a predetermined interrupt generation conditional value to determine whether to generate an interrupt (step S33). Upon determining to generate an interrupt because of the coincidence of the two values, the interrupt determining section 1-8 outputs an interrupt generation signal.

The interrupt control section 1-9 then checks whether the interrupt suppression flag is ON (step S34). If the flag is OFF, the interrupt control section 1-9 turns on the interrupt generation flag (step S35).

If it is determined in step S33 that no interrupt is generated or it is determined in step S34 that the interrupt suppression flag is ON, the state management control section 1-10 checks on the basis of the internal register write end signal whether a write in the internal register 1-6 is completed (step S36). If the write is not completed, the flow returns to step S31. If it is determined in step S36 that the write in the internal register 1-6 is completed, the state management control section 1-10 turns off the interrupt suppression flag and stops outputting the interrupt suppression signal (step S37). Thereafter, the flow returns to step S31.

According to this embodiment, the state management control section 1-10 generates an interrupt suppression signal in accordance with a write request signal to the external register 1-5 and a write end signal from the internal register 1-6. The interrupt control section 1-9 then checks on the basis of the interrupt suppression signal whether an interrupt generation signal is to be masked. This makes it possible to prevent the generation of an erroneous interrupt due to the difference in write timing between the external register 1-5 and the internal register 1-6.

As a consequence, there is no need to ensure a wait time (predetermined time) in software as in the prior art. In addition, no wait is caused with respect to the asynchronous bus interface. That is, even if the macro circuits 1-3 require real-time response performance, since there is no wait time for the CPU 1-1, the processing efficiency of the CPU 1-1 improves.

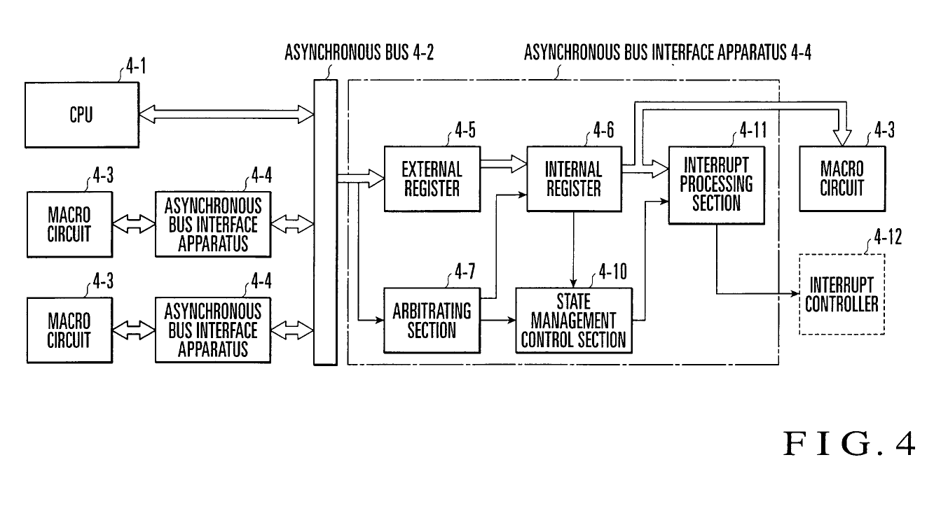

FIG. 4 shows a microcomputer system according to the second embodiment of the present invention. The microcomputer of this embodiment includes a CPU 4-1, an asynchronous bus 4-2, a plurality of macro circuits 4-3, and a plurality of asynchronous bus interface apparatuses 4-4. Each asynchronous bus interface apparatus 4-4 includes an external register 4-5, internal register 4-6, arbitrating section 4-7, state management control section 4-10, and interrupt processing section 4-11. In this embodiment, the interrupt processing section 4-11 has the functions of the interrupt determining section 1-8 and interrupt control section 1-9 in FIG. 1.

The operation of this embodiment will be described next. The operations of the CPU 4-1, asynchronous bus 4-2, external register 4-5, internal register 4-6, arbitrating section 4-7, and state management control section 4-10 are the same as those of the CPU 1-1, asynchronous bus 1-2, external register 1-5, internal register 1-6, arbitrating section 1-7, and state management control section 1-10 shown in FIG. 1.

The interrupt processing section 4-11 compares the internal register value output from the internal register 4-6 with a predetermined interrupt generation conditional value. If they coincide with each other, the interrupt processing section 4-11 checks whether an interrupt suppression signal is output from the state management control section 4-10. If no interrupt suppression signal is output, the interrupt processing section 4-11 turns on an interrupt generation flag and outputs it to an external interrupt controller 4-12. If an interrupt suppression signal is output, the interrupt generation flag is kept off.

According to this embodiment, since no unnecessary interrupt generation signal is output to the outside, unnecessary processing in the CPU 4-1 and other macro circuits 4-3 can be reduced.

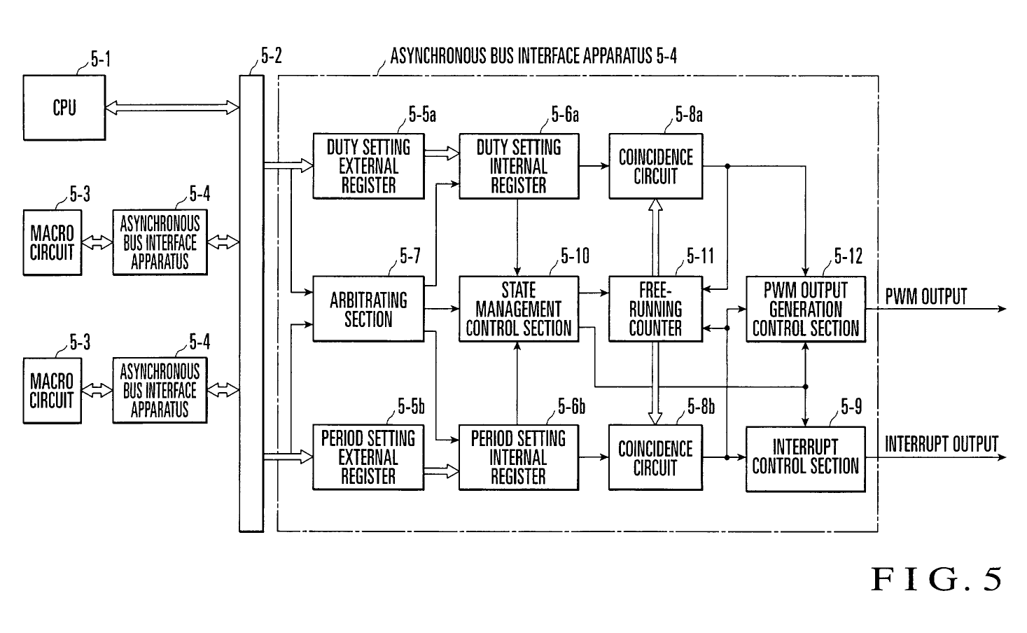

FIG. 5 shows a microcomputer system according to the third embodiment of the present invention. The microcomputer of this embodiment includes a CPU 5-1, an asynchronous bus 5-2, a plurality of macro circuits 5-3, and a plurality of asynchronous bus interface apparatuses 5-4. Each asynchronous bus interface apparatus 5-4 includes a duty setting external register 5-5a, period setting external register 5-5b, duty setting internal register 5-6a, arbitrating section 5-7, coincidence circuits 5-8a and 5-8b, interrupt control section 5-9, state management control section 5-10, free-running counter 5-11, and PWM output generation control section 5-12.

In this embodiment, one asynchronous bus interface apparatus 5-4 incorporates a plurality of registers to allow PWM (Pulse Width Modulator) operation. First of all, the CPU 5-1 sends write data and a write request signal to the duty setting external register 5-5a or period setting external register 5-5b. At this time, the write data written in the duty setting external register 5-5a is duty setting data for a PWM output pulse. The write data written in the period setting external register 5-5b is period setting data for a PWM output pulse.

The arbitrating section 5-7 sets its internal write request flag in accordance with the write request from the CPU 5-1. At this time, when data is to be written in the duty setting external register 5-5a, the arbitrating section 5-7 sets a write request flag corresponding to the duty setting external register 5-5a, whereas when data is to be written in the period setting external register 5-5b, the arbitrating section 5-7 sets a write request flag corresponding to the period setting external register 5-5b.

The arbitrating section 5-7 sends an internal register write signal to the duty setting internal register 5-6a or period setting internal register 5-6b in accordance with the set write request flag. If the write request flag corresponding to the duty setting external register 5-5a is set, the arbitrating section 5-7 sends the internal register write signal to the duty setting internal register 5-6a. If the write request flag corresponding to the period setting external register 5-5b is set, the arbitrating section 5-7 sends the internal register write signal to the period setting internal register 5-6b.

When the internal register write signal is output from the arbitrating section 5-7, the duty setting internal register 5-6a receives and stores the write data output from the duty setting external register 5-5a, and sends the internal register value to a coincidence circuit 5-8a. On the other hand, when the internal register write signal is output from the arbitrating section 5-7, the period setting internal register 5-6b receives and stores the write data output from the period setting external register 5-5b and sends the internal register value to a coincidence circuit 5-8b.

The free-running counter 5-11 outputs an interrupt generation conditional value which is counted up at a predetermined cycle. The free-running counter 5-11 resets the interrupt generation conditional value to an initial value, e.g., “0”, when a coincidence signal is output from the coincidence circuit 5-8b.

The coincidence circuit 5-8a compares the internal register value output from the duty setting internal register 5-6a with the interrupt generation conditional value output from the free-running counter 5-11. If they coincide with each other, the coincidence circuit 5-8a sends a coincidence signal to the PWM output generation control section 5-12. The coincidence circuit 5-8b compares the internal register value output from the period setting internal register 5-6b with the interrupt generation conditional value output from the free-running counter 5-11. If they coincide with each other, the coincidence circuit 5-8b sends a coincidence signal to the interrupt control section 5-9 and PWM output generation control section 5-12.

The PWM output generation control section 5-12 changes the PWM output on the basis of the interrupt suppression control signal output from the state management control section 5-10 and the coincidence signals output from the coincidence circuits 5-8a and 5-8b. When a coincidence signal is output from the coincidence circuit 5-8b, the PWM output generation control section 5-12 raises the PWM output from Low level to High level. When a coincidence signal is output from the coincidence circuit 5-8a, the PWM output generation control section 5-12 lowers the PWM output from High level to Low level.

The state management control section 5-10 generates an interrupt suppression signal on the basis of the write request signal sent from the CPU 5-1 via the arbitrating section 5-7 and the internal register write end signal output from the duty setting internal register 5-6a or period setting internal register 5-6b upon completion of a data write, and sends the signal to the interrupt control section 5-9 and PWM output generation control section 5-12. The state management control section 5-10 resets the free-running counter 5-11 when an internal register write end signal is output from the duty setting internal register 5-6a or period setting internal register 5-6b.

The interrupt control section 5-9 receives the coincidence signal output from the coincidence circuit 5-8b and the interrupt suppression signal output from the state management control section 5-10, and ON/OFF-controls the interrupt generation flag.

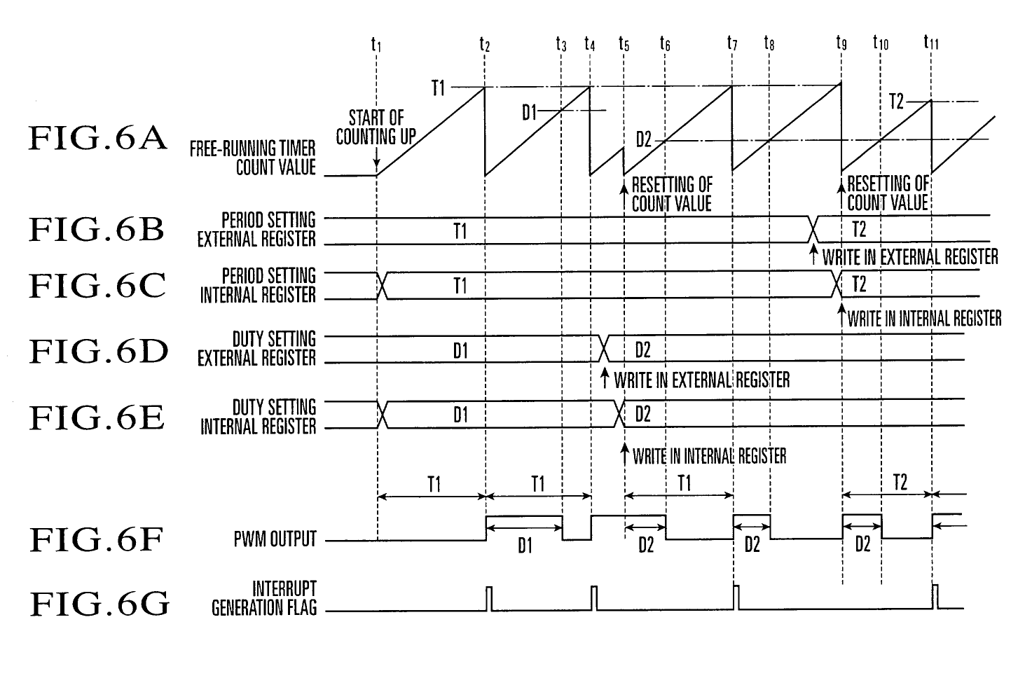

The operation of the above embodiment will be described in more detail next with reference to FIGS. 6A to 6G. First of all, data “T1” from the CPU 5-1 is written in the period setting external register 5-5b in advance (FIG. 6B), and write data “D1” is written in the duty setting external register 5-5a in advance (FIG. 6D). At first, the PWM output is set at Low level.

The period setting external register 5-5b sends the external register value “T1” to the period setting internal register 5-6b. The duty setting external register 5-5a sends the external register value “D1” to the duty setting internal register 5-6a. The period setting internal register 5-6b receives the write data output from the period setting external register 5-5b and rewrites the internal register value to “T1” in accordance with an internal register write signal from the arbitrating section 5-7 (FIG. 6C). The duty setting internal register 5-6a receives the write data output from the duty setting external register 5-5a and rewrites the internal register value to “D1” in accordance with the internal register write signal (FIG. 6E).

When the interrupt generation conditional value, which begins to be counted up at time t1, coincides with the internal register value “T1” in the period setting internal register 5-6b at time t2 (FIG. 6A), a coincidence signal is output from the coincidence circuit 5-8b. With this operation, the PWM output generation control section 5-12 raises the PWM output to High level (FIG. 6F), and the free-running counter 5-11 resets the interrupt generation conditional value to the initial value. The interrupt control section 5-9 turns on the interrupt generation flag because a coincidence signal is output from the coincidence circuit 5-8b and an interrupt suppression signal is not output from the state management control section 5-10 (FIG. 6G).

At time t2, the interrupt generation conditional value begins to be counted up. When the internal register value “D1” in the duty setting internal register 5-6a coincides with the interrupt generation conditional value at time t3, a coincidence signal is output from the coincidence circuit 5-8a. With this operation, the PWM output generation control section 5-12 lowers the PWM output to Low level. The operation at time t4 is the same as that at time t2.

The CPU 5-1 then sends write data “D2” and a write request signal to the duty setting external register 5-5a. The duty setting external register 5-5a rewrites the external register value from “D1” to “D2” in accordance with the write request signal. The arbitrating section 5-7 sends an internal register write signal to the duty setting internal register 5-6a.

When the internal register write signal is output from the arbitrating section 5-7, the duty setting internal register 5-6a receives the write data output from the duty setting external register 5-5a and rewrites the internal register value to “D2”. When the internal register value is rewritten and an internal register write end signal is output from the duty setting internal register 5-6a, the state management control section 5-10 resets the free-running counter 5-11 at time t5.

At time t5, the interrupt generation conditional value begins to be counted up. When the internal register value “D2” in the duty setting internal register 5-6a coincides with the interrupt generation conditional value at time t6, a coincidence signal is output from the coincidence circuit 5-8a. With this operation, the PWM output generation control section 5-12 lowers the PWM output to Low level. The operations at times t7 and t8 are the same as those at times t2 and t6.

The CPU 5-1 then sends write data “t2” and a write request signal to the period setting external register 5-5b. The period setting external register 5-5b rewrites the external register value from “T1” to “t2” in accordance with the write request signal. The arbitrating section 5-7 sends an internal register write signal to the period setting internal register 5-6b.

When an internal register write signal is output from the arbitrating section 5-7, the period setting internal register 5-6b receives the write data output from the period setting external register 5-5b and rewrites the internal register value to “t2”. When the internal register value is rewritten and an internal register write end signal is output from the period setting external register 5-5b, the state management control section 5-10 resets the free-running counter 5-11 at time t9.

Although the interrupt generation flag should be turned on at time t9 as with the case at times t2, t4, and t4, the time interval between the register value rewrite start time in the period setting external register 5-5b and the register value rewrite end time in the period setting internal register 5-6b is set as an interrupt suppression interval, and the state management control section 5-10 generates an interrupt suppression signal. For this reason, even if a coincidence signal is output from the coincidence circuit 5-8b, the interrupt control section 5-9 does not change the interrupt generation flag and keeps it off. The operation at time t10 is the same as that at time t6.

At time t11, the internal register value “T2” in the period setting internal register 5-6b coincides with the interrupt generation conditional value, and the coincidence circuit 5-8b outputs a coincidence signal. With this operation, the PWM output generation control section 5-12 raises the PWM output to High level, the free-running counter 5-11 resets the interrupt generation conditional value, and the interrupt control section 5-9 turns on the interrupt generation flag.

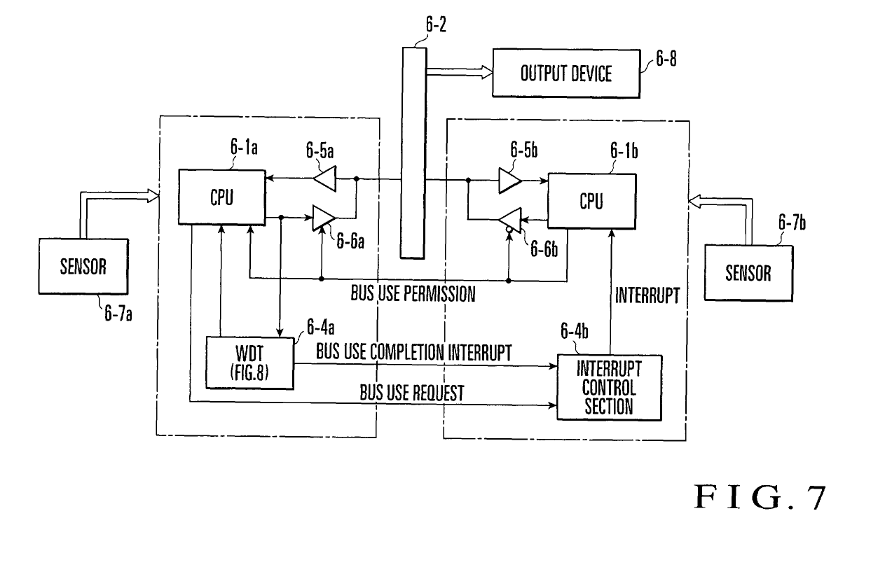

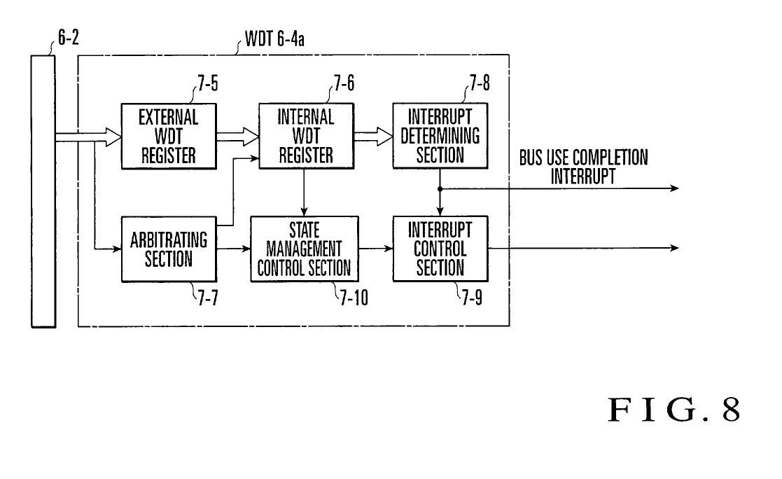

FIG. 7 shows a microcomputer system according to the fourth embodiment of the present invention. The microcomputer system of this embodiment includes CPUs 6-1a and 6-1b, an asynchronous bus 6-2, a watch dog timer (WDT) 6-4a which is an asynchronous bus interface apparatus, an interrupt control section 6-4b, bus drivers 6-5a, 6-5b, 6-6a, and 6-6b, sensors 6-7a and 6-7b, and an output device (digital panel) 6-8. As shown in FIG. 8, the WDT 6-4a includes an external WDT register 7-5, internal WDT register 7-6, arbitrating section 7-7, interrupt determining section 7-8, and interrupt control section 7-9.

In this embodiment, the arrangement of the first embodiment is applied to a register in which a usable time for the WDT 6-4a is set. Output results from the sensors 6-7a and 6-7b are displayed on the output device 6-8 via the CPUs 6-1a and 6-1b and asynchronous bus 6-2. The CPUs 6-1b and 6-1a serve as a bus master and bus slave, respectively.

While the CPU 6-1b uses the asynchronous bus 6-2, the bus driver 6-6a is set in an inactive state, and the bus driver 6-6b is set in an active state. The output result from the sensor 6-7b is displayed on the output device 6-8 through the CPU 6-1b, bus driver 6-6b, and asynchronous bus 6-2.

When the CPU 6-1a is to use the asynchronous bus 6-2, the CPU 6-1a sends a bus use request to the interrupt control section 6-4b on the CPU 6-1b side. With this operation, the interrupt control section 6-4b causes an interrupt with respect to the CPU 6-1b. If the CPU 6-1a is allowed to use the asynchronous bus 6-2, the CPU 6-1b sets a usable time in the WDT 6-4a. That is, the CPU 6-1b sends write data (usable time) and a write request signal to the external WDT register 7-5 of the WDT 6-4a via the asynchronous bus 6-2.

The external WDT register 7-5 receives the write data in accordance with the write request signal. The arbitrating section 7-7 sends an internal register write signal to the internal WDT register 7-6 in accordance with the write request from the CPU 6-1b. When an internal register write signal is output from the arbitrating section 7-7, the internal WDT register 7-6 receives the write data output from the external WDT register 7-5 and rewrites the internal register value.

After setting a usable time in the WDT 6-4a, the CPU 6-1b outputs a bus use permission to the CPU 6-1a. With this operation, the bus driver 6-6a is set in an active state, and the bus driver 6-6b is set in an inactive state. In this state, an output result from the sensor 6-7a is displayed on the output device 6-8 via the CPU 6-1a, bus driver 6-6a, and asynchronous bus 6-2.

The interrupt determining section 7-8 of the WDT 6-4a has a timer for measuring the time elapsed since the internal register value was rewritten. The interrupt determining section 7-8 compares the internal register value (usable time) output from the internal WDT register 7-6 with the elapsed time measured by the timer. If the internal register value coincides with the elapsed time, the interrupt determining section 7-8 sends a bus use completion interrupt signal to the interrupt control section 7-9 and the interrupt control section 6-4b on the CPU 6-1b side.

A state management control section 7-10 generates an interrupt suppression signal on the basis of the write request signal sent from the CPU 6-1b via the arbitrating section 7-7 and the internal register write end signal output from the internal WDT register 7-6, and sends the signal to the interrupt control section 7-9 as in the first embodiment.

The interrupt control section 7-9 receives the bus use completion interrupt signal output from the interrupt determining section 7-8 and the interrupt suppression signal output from the state management control section 7-10, and ON/OFF-controls the interrupt generation flag. When a bus use completion interrupt signal is output and no interrupt suppression signal is output, the interrupt control section 7-9 turns on the interrupt generation flag. When a bus use completion interrupt signal is output and an interrupt suppression signal is output, the interrupt control section 7-9 keeps the interrupt generation flag OFF.

When a bus use completion interrupt signal is output from the WDT 6a and an interrupt generation flag is ON, the interrupt control section 6-4b on the CPU 6-1b side causes a bus use completion interrupt with respect to the CPU 6-1b. In accordance with this bus use completion interrupt, the CPU 6-1b cancels the bus use permission with respect to the CPU 6-1a. With this operation, the bus driver 6-6a is set in an inactive state, and the bus driver 6-6b is set in an active state. Consequently, the state wherein the asynchronous bus 6-2 is used is restored.

According to this embodiment, since the CPU 6-1a can use the asynchronous bus 6-2 immediately after a usable time is set, the present invention is especially effective when the use frequency of the asynchronous bus 6-2 by the CPU 6-1a is larger than that by the CPU 6-1b.

As has been described above, according to the present invention, since the difference between the timings of data storage in an external register and data storage in an internal register is recognized and set as an interrupt suppression interval, the generation of an interrupt due to the difference in write timing between the external register and the internal register can be prevented. This eliminates the necessity to ensure a wait time (predetermined time) by software as in the prior art. In addition, no wait is caused with respect to an asynchronous bus interface. That is, even if the macro circuits require real-time response performance, since there is no wait time for the microcomputer, the processing efficiency of the microcomputer improves.

What is claimed is:

1. An asynchronous bus interface apparatus arranged between an asynchronous bus and a macro circuit, comprising:
external register means which temporarily stores write data for a microprocessor in accordance with a write request signal sent from the microprocessor via the asynchronous bus;
arbitrating means for generating an internal register write signal in synchronism with an operation clock from the macro circuit upon reception of the write request signal from the microprocessor;
internal register means which reads data output from said external register means when the internal register write signal is input from said arbitrating means, temporarily stores the data, and outputs the stored data in synchronism with the operation clock from the macro circuit; and
state management control means for recognizing a difference between a data storage timing in said external register means and a data storage timing in said internal register means, and suppresses generation of an interrupt in an interval corresponding to the difference.

2. An apparatus according to claim 1, wherein said state management control means generates an interrupt suppression signal on the basis of a write request signal sent from the microprocessor via the asynchronous bus and an internal register write end signal output from said internal register.

3. An apparatus according to claim 2, further comprising interrupt control means for ON/OFF-controlling an interrupt generation flag output from an external interrupt controller on the basis of an interrupt suppression signal from said state management control means when an interrupt is generated.

4. An apparatus according to claim 3, wherein said interrupt control means keeps off an interrupt generation flag output to said external interrupt controller when an interrupt suppression signal is output from said state management control means upon reception of an interrupt generation signal.

5. An apparatus according to claim 3, further comprising interrupt determination means for outputting an interrupt generation signal to said interrupt control means and said interrupt controller when an internal register value output from said internal register is compared with a predetermined interrupt generation conditional value, and the two values coincide with each other.

6. An apparatus according to claim 5, wherein said interrupt determination means comprises a memory in which a predetermined interrupt generation conditional value is stored in advance.

7. An apparatus according to claim 2, further comprising interrupt processing means for comparing an internal register value output from said internal register means with a predetermined interrupt generation conditional value, checking, if the two values coincide with each other, whether an interrupt suppression signal is output from said state management control means, and ON/OFF-controlling an interrupt generation flag output from said external interrupt controller on the basis of the check result.

8. An apparatus according to claim 2, wherein said external register means comprises first and second external registers in which duty setting data and period setting data for a PWM (Pulse Width Modulator) output pulse which are sent from the microprocessor via the asynchronous bus are respectively written,
said internal register means comprises first and second internal registers in which duty setting data and period setting data set in correspondence with said first and second external registers are respectively written,
said arbitrating means instructs to perform a write in one of said first and second external registers in accordance with a write request from the microprocessor, and
said state management control means generates an interrupt suppression signal on the basis of a write request signal sent from the microprocessor via the asynchronous bus and an internal register write end signal output from one of said first and second internal registers.

9. An apparatus according to claim 8, further comprising:
count means for outputting an interrupt generation conditional value which is counted up at a predetermined cycle;
first coincidence means for outputting a coincidence signal to reset said count circuit when the internal register value output from said first internal register coincides with the interrupt generation conditional value output from said count means;
second coincidence means for outputting a coincidence signal when the internal register value output from said second internal register coincides with the interrupt generation conditional value output from said counter means;
PWM output generation control means for changing a PWM output on the basis of an interrupt suppression signal output from said state management control means and coincidence signals output from said first and second coincidence means; and
interrupt control means for ON/OFF-controlling an interrupt generation flag on the basis of the coincidence signal output from said second coincidence means and the interrupt suppression signal output from said state management control means.

10. An apparatus according to claim 1, wherein
said apparatus further comprises another microprocessor which shares the asynchronous bus with the microprocessor, and
the write data sent from the microprocessor to said external register is a bus usable time set from said another microprocessor which is using the asynchronous bus via the microprocessor.
